(19) United States
(12) Patent Application Publication
(10) Pub. No.: US 2018/0094564 A1
(43) Pub. Date: Apr. 5, 2018

(54) GAS SENSOR, CATALYST DIAGNOSIS SYSTEM, AND CATALYST DIAGNOSTIC METHOD

(71) Applicant: NGK INSULATORS, LTD., Nagoya-shi (JP)

(72) Inventors: Taku OKAMOTO, Nagoya-shi (JP); Nobuhiko MORI, Nagoya-shi (JP); Yuki NAKAYAMA, Nagoya-shi (JP); Noriko HIRATA, Nagoya-shi (JP)

(21) Appl. No.: 15/708,380

(22) Filed: Sep. 19, 2017

(30) Foreign Application Priority Data
Sep. 30, 2016 (JP) 2016-193402

(51) Int. Cl. F01N 11/00; G01N 27/406; G01N 27/407; G01N 27/41; F01N 13/00

(52) U.S. Cl. CPC F01N 11/002; G01N 27/4067; G01N 27/4075; B01D 53/944; G01N 27/4071; G01N 27/4065; F01N 13/008; G01N 27/41

(57) ABSTRACT

In a gas sensor determining a NOx concentration in a measurement gas based on a pump current flowing between a NOx measurement electrode and an outer pump electrode, the outer pump electrode has catalytic activity inactivated for HC and CO, so that a sensor element further includes a HC sensor part having a mixed potential cell constituted by the outer pump electrode, a reference electrode, and a solid electrolyte between these electrodes, and a HC mode for determining a HC concentration in the measurement gas based on a potential difference between the outer pump electrode and the reference electrode when the sensor element is heated to a temperature which is 400° C. or higher and 650° C. or lower and a NOx mode for determining a NOx concentration in the measurement gas based on the pump current can selectively be performed based on the temperature of the sensor element.

### BACKGROUND OF THE INVENTION

### Field of the Invention

The present invention relates to a gas sensor for detecting a predetermined gas component in a measurement gas and diagnosis, made using the gas sensor, of the state of a catalyst located on an exhaust path of an internal combustion engine.

### Description of the Background Art

Various gas sensors have been used to obtain the concentration of a desired gas component in a measurement gas. For example, as an apparatus for measuring a NOx concentration in a measurement gas, such as a combustion gas, a NOx sensor including a sensor element formed of an oxygen-ion conductive solid electrolyte, such as zirconia (ZrO₂), is known (see, for example, Japanese Patent No. 3756123, Japanese Patent No. 3798412, and Japanese Patent No. 3771569).

A method of diagnosing NO/NO₂ transforming ability of a diesel oxidation catalyst (DOC) using a degradation diagnostic apparatus that includes a multi-sensor including a NOx sensor part and a NO₂ sensor part by providing an additional electrode to a NOx sensor to diagnose an aging level of the DOC is already known (see, for example, Japanese Patent Application Laid-Open Publication No. 2014-62541).

The multi-gas sensor disclosed in Japanese Patent Application Laid-Open Publication No. 2014-62541 includes the NOx sensor part for sensing NOx and the NO₂ sensor part for sensing NO₂ independently of each other. In this multi-gas sensor, electrodes included in each of the sensor parts and lead wires connecting the electrodes to the outside are independently provided. Accordingly, such a sensor has constraints on the layout of the electrodes and routing of wiring, and has little freedom of element design.

The multi-gas sensor disclosed in Japanese Patent Application Laid-Open Publication No. 2014-62541 includes a lamination of alternating solid electrolyte layers and insulating layers, and includes the NO₂ sensor part including a reference electrode and a sensing electrode located on a solid electrolyte layer serving as an outer surface of a sensor element.

The multi-gas sensor disclosed in Japanese Patent Application Laid-Open Publication No. 2014-62541 measures a NO₂ concentration using change of electromotive force occurring between the both electrodes, and, however, due to the layout of the electrodes as described above, the reference electrode providing a reference potential is exposed to the measurement gas. The reference potential thus fluctuates due to the effect of fluctuation of an oxygen concentration in the measurement gas. Thus, the NO₂ concentration might not suitably be measured.

### SUMMARY

The present invention relates to a gas sensor for detecting a predetermined gas component in a measurement gas and diagnosis, made using the gas sensor, of the state of a catalyst located on an exhaust path of an internal combustion engine.

According to the present invention, a gas sensor for detecting a predetermined gas component in a measurement gas includes: a sensor element including a lamination of a plurality of oxygen-ion conductive solid electrolyte layers; and a heater located inside the sensor element to heat the sensor element. The sensor element includes: a NOx sensor part; and a HC sensor part. The NOx sensor part includes: at least one internal space into which the measurement gas is introduced from an external space; a NOx measurement electrode formed to face the at least one internal space; an outer pump electrode formed on a surface of the sensor element; and a reference electrode located between two of the plurality of oxygen-ion conductive solid electrolyte layers to be in contact with a reference gas, and has a measurement pump cell that is an electrochemical pump cell constituted by the NOx measurement electrode, the outer pump electrode, and a solid electrolyte between the NOx measurement electrode and the outer pump electrode. The HC sensor part has a mixed potential cell constituted by the outer pump electrode, the reference electrode, and a solid electrolyte between the outer pump electrode and the reference electrode. The outer pump electrode has catalytic activity inactivated for a hydrocarbon gas and carbon monoxide. The gas sensor is configured to be capable of selectively performing a HC mode for determining a HC concentration in the measurement gas and a NOx mode for determining a NOx concentration in the measurement gas in accordance with temperature of the sensor element. In the HC mode, the heater heats at least the HC sensor part of the sensor element to a first temperature which is 400° C. or higher and 650° C. or lower, and the gas sensor determines the HC concentration based on a potential difference occurring between the outer pump electrode and the reference electrode in the mixed potential cell. In the NOx mode, the heater heats at least the NOx sensor part of the sensor element to a second temperature which is 600° C. or higher and 900° C. or lower, and is higher than the first temperature, and the gas sensor determines the NOx concentration based on a pump current flowing between the NOx measurement electrode and the outer pump electrode in a state of controlling a voltage applied between the NOx measurement electrode and the outer pump electrode to maintain a potential difference between the NOx measurement electrode and the reference electrode constant.

The outer pump electrode is preferably formed of a cermet composed of a noble metal and an oxygen-ion conductive solid electrolyte. The noble metal is a Pt—Au alloy, and an Au abundance ratio being an area ratio of a portion covered with Au to a portion at which Pt is exposed in the surface of noble metal particles included in the outer pump electrode is 0.25 or more and 2.30 or less.

The at least one internal space preferably includes a first internal space and a second internal space. The NOx measurement electrode is located inside the second internal space, and has NOx reducing ability. The sensor element further includes: a gas inlet through which the measurement gas is introduced from the external space into the sensor element; an inner pump electrode formed to face the first internal space; and an auxiliary pump electrode formed to face the second internal space. The gas inlet and the first internal space, and the first internal space and the second internal space each communicate with each other via a diffusion control part providing a predetermined diffusion resistance to the measurement gas. The inner pump electrode, the outer pump electrode, and a solid electrolyte between the inner pump electrode and the outer pump electrode constitute a main pump cell pumping in or pumping out oxygen between the first internal space and the external space. The auxiliary pump electrode, the outer pump electrode, and a solid electrolyte between the auxiliary pump electrode and the outer pump electrode constitute an auxiliary pump cell that is an electrochemical pump cell pumping out oxygen from the second internal space to the external space. The measurement pump cell pumps out oxygen generated by reducing, with the NOx measurement electrode, NOx in the measurement gas having oxygen partial pressure controlled by the main pump cell and the auxiliary pump cell, thereby allowing the pump current to flow between the NOx measurement electrode and the outer pump electrode.

According to the present invention, the gas sensor (multi-gas sensor) that can selectively be used in the HC mode and in the NOx mode by only changing the control temperature, and thus functions as the HC sensor and as the NOx sensor is achieved without complicating the configuration of a conventional NOx sensor.

According to another aspect of the present invention, a catalyst diagnosis system for diagnosing a state of a catalyst that is located on an exhaust path of an internal combustion engine, and oxidizes or adsorbs a target gas containing at least one of a hydrocarbon gas and a carbon monoxide gas included in an exhaust gas from the internal combustion engine includes the gas sensor according to the present invention located downstream from the catalyst on the exhaust path, and includes a temperature sensor outputting temperature of the catalyst; and a controller controlling the catalyst diagnosis system. Threshold data describing a threshold condition for use in diagnosis of degradation of the catalyst is set in advance, and held in a predetermined storage. The controller is configured to: cause the heater to heat the sensor element so that at least the HC sensor part is heated to the first temperature from starting of the internal combustion engine; obtain, over time, the potential difference occurring between the outer pump electrode and the reference electrode in the mixed potential cell while maintaining the HC sensor part at the first temperature; identify the temperature of the catalyst output from the temperature sensor when the potential difference decreases to meet the threshold condition as a light-off temperature of the catalyst; and diagnose a degree of degradation of the catalyst based on the light-off temperature.

The degree of degradation of an oxidation catalyst can thus be diagnosed from level of the light-off temperature of the oxidation catalyst determined based on change of an output value from the gas sensor being in the HC mode.

The controller is preferably configured to: cause the heater to heat the sensor element so that at least the NOx sensor part is heated to the second temperature after identification of the light-off temperature; and be capable of monitoring the NOx concentration at a location downstream from the catalyst during steady-state operation of the internal combustion engine based on the pump current flowing between the NOx measurement electrode and the outer pump electrode when the NOx sensor part is at the second temperature.

This enables diagnosis of degradation of the oxidation catalyst in the HC mode at starting of the internal combustion engine and monitoring of the NOx concentration in the NOx mode during the steady-state operation.

An object of the present invention is to provide a gas sensor having simpler configuration than a conventional multi-gas sensor, and being suitably usable in diagnosis of the state of a catalyst.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows an example of the configuration of a gas sensor 100 including a vertical sectional view taken along the longitudinal direction of a sensor element 101;

FIG. 2 shows a processing flow in the manufacture of the sensor element 101;

FIG. 3 shows schematic configuration of an engine system 1000 including an oxidation catalyst diagnosis system DS1 including the gas sensor 100;

FIG. 4 shows a specific example of a processing flow in the oxidation catalyst diagnosis system DS1 when the engine system 1000 is started;

FIG. 5 shows sensitivity characteristics obtained in Working Example 1;

FIG. 6 shows evaluation results of the amount of CO adsorbed by CO pulse adsorption targeted at an oxidation catalyst 600 in Working Example 2 to see the effect of aging;

FIGS. 7A and 7B respectively show, for a “new” oxidation catalyst 600, an output value from a mixed potential cell 61 and the temperature of the oxidation catalyst 600, and a change over time of the concentration of an unburned HC gas from key-on at a location upstream from the oxidation catalyst 600 and at a location downstream from the oxidation catalyst 600;

FIGS. 8A and 8B respectively show, for an oxidation catalyst 600 “aged at 650° C.”, the output value from the mixed potential cell 61 and the temperature of the oxidation catalyst 600, and the change over time of the concentration of the unburned HC gas from key-on at the location upstream from the oxidation catalyst 600 and at the location downstream from the oxidation catalyst 600; and

FIGS. 9A and 9B respectively show, for an oxidation catalyst 600 “aged at 850° C.”, the output value from the mixed potential cell 61 and the temperature of the oxidation catalyst 600, and the change over time of the concentration of the unburned HC gas from key-on at the location upstream from the oxidation catalyst 600 and at the location downstream from the oxidation catalyst 600.

### DESCRIPTION OF THE PREFERRED EMBODIMENTS

<Schematic Configuration of Gas Sensor>

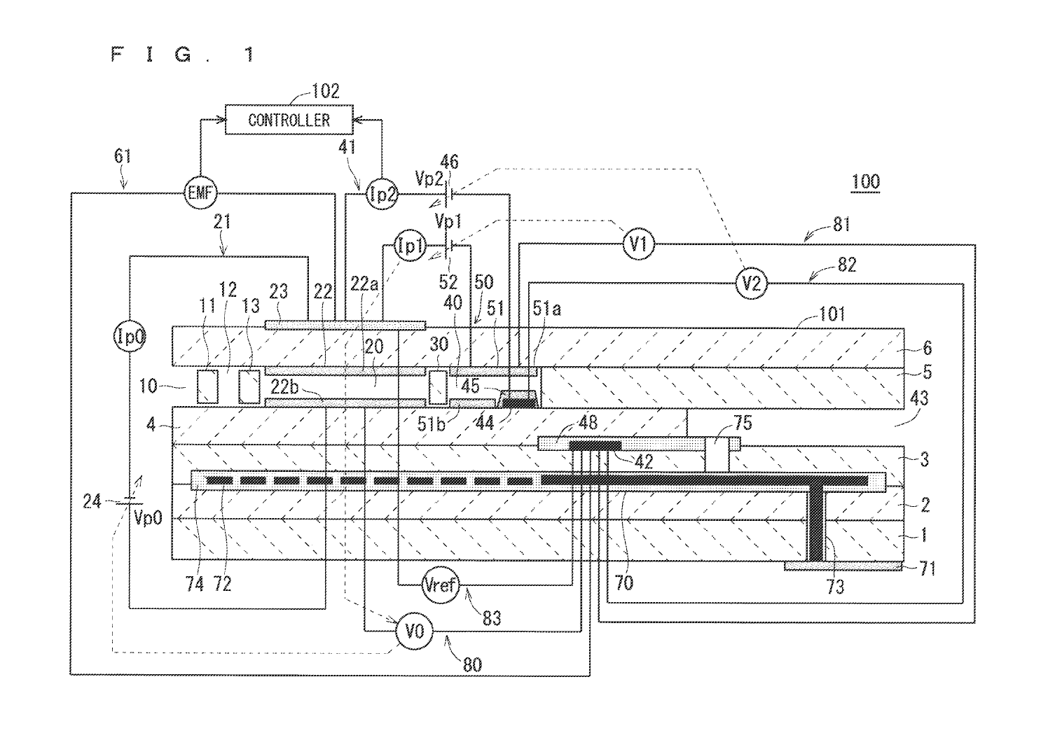

Schematic configuration of a gas sensor 100 according to the present embodiment will be described. FIG. 1 schematically shows an example of the configuration of the gas sensor 100 including a vertical sectional view taken along the longitudinal direction of a sensor element 101, which is a main component of the gas sensor 100. The sensor element 101 has a structure in which six layers, namely, a first substrate layer 1, a second substrate layer 2, a third substrate layer 3, a first solid electrolyte layer 4, a spacer layer 5, and a second solid electrolyte layer 6, each being an oxygen-ion conductive solid electrolyte layer formed, for example, of zirconia (ZrO₂), are laminated in the stated order from the bottom side of FIG. 1. Solid electrolytes forming these six layers are dense and airtight. The sensor element 101 is manufactured, for example, by performing predetermined machining and printing of circuit patterns with respect to ceramic green sheets corresponding to respective layers, then laminating these green sheets, and further firing the laminated green sheets for integration.

Between a lower surface of the second solid electrolyte layer 6 and an upper surface of the first solid electrolyte layer 4 at one end portion of the sensor element 101, a gas inlet 10, a first diffusion control part 11, a buffer space 12, a second diffusion control part 13, a first internal space 20, a third diffusion control part 30, and a second internal space 40 are formed adjacent to each other to communicate in the stated order.

The gas inlet 10, the buffer space 12, the first internal space 20, and the second internal space 40 are spaces inside the sensor element 101 that look as if they were provided by hollowing out the spacer layer 5, and that have an upper portion, a lower portion, and a side portion respectively defined by the lower surface of the second solid electrolyte layer 6, the upper surface of the first solid electrolyte layer 4, and a side surface of the spacer layer 5.

The first diffusion control part 11, the second diffusion control part 13, and the third diffusion control part 30 are each provided as two horizontally long slits (openings whose longitudinal direction is a direction perpendicular to the plane of FIG. 1). A part extending from the gas inlet 10 to the second internal space 40 is also referred to as a gas distribution part.

At a location farther from the end portion than the gas distribution part is, a reference gas introduction space 43 having a side portion defined by a side surface of the first solid electrolyte layer 4 is provided between an upper surface of the third substrate layer 3 and a lower surface of the spacer layer 5. Atmospheric air is introduced as a reference gas into the reference gas introduction space 43.

An atmospheric air introduction layer 48 is a layer formed of porous alumina, and the atmospheric air as the reference gas is introduced into the atmospheric air introduction layer 48 through the reference gas introduction space 43. The atmospheric air introduction layer 48 is formed to cover a reference electrode 42.

The reference electrode 42 is an electrode formed to be sandwiched between the upper surface of the third substrate layer 3 and the first solid electrolyte layer 4, and the atmospheric air introduction layer 48 leading to the reference gas introduction space 43 is provided around the reference electrode 42, as described above. As will be described below, an oxygen concentration (oxygen partial pressure) in the first internal space 20 and the second internal space 40 can be measured using the reference electrode 42.

In the gas distribution part, the gas inlet 10 opens to an external space, and a measurement gas is taken from the external space into the sensor element 101 through the gas inlet 10.

The first diffusion control part 11 is a part providing a predetermined diffusion resistance to the measurement gas taken through the gas inlet 10.

The buffer space 12 is a space provided to guide the measurement gas introduced from the first diffusion control part 11 to the second diffusion control part 13.

The second diffusion control part 13 is a part providing a predetermined diffusion resistance to the measurement gas introduced from the buffer space 12 into the first internal space 20.

When the measurement gas is introduced from the outside of the sensor element 101 into the first internal space 20, the measurement gas, which is abruptly taken into the sensor element 101 through the gas inlet 10 due to pressure fluctuation of the measurement gas in the external space (pulsation of exhaust pressure in a case where the measurement gas is an exhaust gas of an automobile), is not directly introduced into the first internal space 20, but is introduced into the first internal space 20 after the concentration fluctuation of the measurement gas is canceled through the first diffusion control part 11, the buffer space 12, and the second diffusion control part 13. This makes the concentration fluctuation of the measurement gas introduced into the first internal space 20 almost negligible.

The first internal space 20 is provided as a space used to adjust oxygen partial pressure in the measurement gas introduced through the second diffusion control part 13. The oxygen partial pressure is adjusted by operation of a main pump cell 21.

The main pump cell 21 is an electrochemical pump cell constituted by an inner pump electrode 22, an outer pump electrode 23, and the second solid electrolyte layer 6 sandwiched between the inner pump electrode 22 and the outer pump electrode 23. The inner pump electrode 22 has a ceiling electrode portion 22a that is provided substantially on the entire lower surface of a portion of the second solid electrolyte layer 6 facing the first internal space 20. The outer pump electrode 23 is provided in a region, on an upper surface of the second solid electrolyte layer 6, corresponding to the ceiling electrode portion 22a so as to be exposed to the external space.

The inner pump electrode 22 is formed over upper and lower solid electrolyte layers (the second solid electrolyte layer 6 and the first solid electrolyte layer 4) that define the first internal space 20, and the spacer layer 5 that provides a side wall to the first internal space 20. Specifically, the ceiling electrode portion 22a is formed on the lower surface of the second solid electrolyte layer 6, which provides a ceiling surface to the first internal space 20, a bottom electrode portion 22b is formed on the upper surface of the first solid electrolyte layer 4, which provides a bottom surface to the first internal space 20, and a side electrode portion (not illustrated) is formed on a side wall surface (internal surface) of the spacer layer 5 that forms opposite side wall portions of the first internal space 20 to connect the ceiling electrode portion 22a and the bottom electrode portion 22b. The inner pump electrode 22 is thus provided in the form of a tunnel at a location where the side electrode portion is provided.

The inner pump electrode 22 is formed as a porous cermet electrode (e.g., a cermet electrode formed of ZrO₂ and Pt that contains Au of 1%). The inner pump electrode 22 to be in contact with the measurement gas is formed using a material having a weakened reducing ability with respect to a NOx component in the measurement gas.

Similarly, the outer pump electrode 23 is formed as a porous cermet electrode made of Pt containing a predetermined ratio of Au, namely, a Pt—Au alloy, and zirconia. The outer pump electrode 23 is formed to have catalytic activity inactivated for a hydrocarbon (HC) gas and a carbon monoxide (CO) gas (hereinafter, also collectively referred to as a HC gas, or simply referred to as HC), that is, to prevent or reduce the decomposition reaction of the HC gas in a predetermined concentration range. Thus, in the gas sensor 100, the potential of the outer pump electrode 23 selectively varies for (has correlation with) HC in the predetermined concentration range in accordance with the concentration thereof. In other words, the outer pump electrode 23 is provided to have high concentration dependence of the potential for the HC gas in the predetermined concentration range while having low concentration dependence of the potential for other components of the measurement gas. Details of this point will be described below.

The main pump cell 21 can pump out oxygen in the first internal space 20 to the external space or pump in oxygen in the external space to the first internal space 20 by applying, using a variable power supply 24, a desired pump voltage Vp0 across the inner pump electrode 22 and the outer pump electrode 23 to allow a pump current Ip0 to flow between the inner pump electrode 22 and the outer pump electrode 23 in a positive or negative direction.

To detect an oxygen concentration (oxygen partial pressure) in the atmosphere existing in the first internal space 20, the inner pump electrode 22, the second solid electrolyte layer 6, the spacer layer 5, the first solid electrolyte layer 4, the third substrate layer 3, and the reference electrode 42 constitute an electrochemical sensor cell, namely, a main-pump-control oxygen-partial-pressure detection sensor cell 80.

The oxygen concentration (oxygen partial pressure) in the first internal space 20 can be obtained by measuring electromotive force V0 in the main-pump-control oxygen-partial-pressure detection sensor cell 80.

Furthermore, the pump current Ip0 is controlled by performing feedback control of the voltage Vp0 so that the electromotive force V0 is maintained constant. The oxygen concentration in the first internal space 20 is thereby maintained to have a predetermined constant value.

The third diffusion control part 30 is a part providing a predetermined diffusion resistance to the measurement gas having an oxygen concentration (oxygen partial pressure) controlled by the operation of the main pump cell 21 in the first internal space 20, and guiding the measurement gas to the second internal space 40.

The second internal space 40 is provided as a space to perform processing concerning determination of a nitrogen oxide (NOx) concentration in the measurement gas introduced through the third diffusion control part 30. The NOx concentration is determined, mainly in the second internal space 40 in which an oxygen concentration has been adjusted by an auxiliary pump cell 50, by the operation of a measurement pump cell 41.

After the oxygen concentration (oxygen partial pressure) is adjusted in advance in the first internal space 20, the auxiliary pump cell 50 further adjusts the oxygen partial pressure of the measurement gas introduced through the third diffusion control part in the second internal space 40. Owing to such adjustment, the oxygen concentration in the second internal space 40 can be maintained constant with high precision, and thus the gas sensor 100 is enabled to determine the NOx concentration with high precision.

The auxiliary pump cell 50 is an auxiliary electrochemical pump cell constituted by an auxiliary pump electrode 51, the outer pump electrode 23 (not limited to the outer pump electrode 23 but may be any appropriate electrode outside the sensor element 101), and the second solid electrolyte layer 6. The auxiliary pump electrode 51 has a ceiling electrode portion 51a that is provided substantially on the entire lower surface of a portion of the second solid electrolyte layer 6 facing the second internal space 40.

The auxiliary pump electrode 51 is provided in the second internal space 40 in the form of a tunnel, as with the inner pump electrode 22 provided in the first internal space 20 described previously. That is to say, the ceiling electrode portion 51a is formed on the second solid electrolyte layer 6, which provides a ceiling surface to the second internal space 40, a bottom electrode portion now abandoned 51b is formed on the first solid electrolyte layer 4, which provides a bottom surface to the second internal space 40, and a side electrode portion (not illustrated) that connects the ceiling electrode portion 51a and the bottom electrode portion 51b is formed on opposite wall surfaces of the spacer layer 5, which provides a side wall to the second internal space 40. The auxiliary pump electrode 51 is thus provided in the form of a tunnel.

As with the inner pump electrode 22, the auxiliary pump electrode 51 is formed using a material having a weakened reducing ability with respect to a NOx component in the measurement gas.

The auxiliary pump cell 50 can pump out oxygen in the atmosphere existing in the second internal space 40 to the external space or pump in oxygen existing in the external space to the second internal space 40 by applying a desired voltage Vp1 across the auxiliary pump electrode 51 and the outer pump electrode 23.

In order to control the oxygen partial pressure in the atmosphere in the second internal space 40, the auxiliary pump electrode 51, the reference electrode 42, the second solid electrolyte layer 6, the spacer layer 5, the first solid electrolyte layer 4, and the third substrate layer 3 constitute an electrochemical sensor cell, namely, an auxiliary-pump-control oxygen-partial-pressure detection sensor cell 81.

The auxiliary pump cell 50 performs pumping using a variable power supply 52 whose voltage is controlled based on electromotive force V1 detected by the auxiliary-pump-control oxygen-partial-pressure detection sensor cell 81. The oxygen partial pressure in the atmosphere in the second internal space 40 is thereby controlled to a low partial pressure having substantially no effect on detection of NOx.

At the same time, a resulting pump current Ip1 is used to control electromotive force in the main-pump-control oxygen-partial-pressure detection sensor cell 80. Specifically, the pump current Ip1 is input, as a control signal, into the main-pump-control oxygen-partial-pressure detection sensor cell 80, and, through control of the electromotive force V0 thereof, the oxygen partial pressure in the measurement gas introduced through the third diffusion control part 30 into the second internal space 40 is controlled to have a gradient that is always constant. In use as a NOx sensor, the oxygen concentration in the second internal space 40 is maintained to have a constant value of approximately 0.001 ppm by the action of the main pump cell 21 and the auxiliary pump cell 50.

The measurement pump cell 41 detects NOx in the measurement gas in the second internal space 40. The measurement pump cell 41 is an electrochemical pump cell constituted by a NOx measurement electrode (hereinafter, simply referred to as a measurement electrode) 44, the outer pump electrode 23, the second solid electrolyte layer 6, the spacer layer 5, and the first solid electrolyte layer 4. The measurement electrode 44 is provided on an upper surface of a portion of the first solid electrolyte layer 4 facing the second internal space 40 to be separated from the third diffusion control part 30.

The measurement electrode 44 is a porous cermet electrode. The measurement electrode 44 also functions as a NOx reduction catalyst that reduces NOx existing in the atmosphere in the second internal space 40. The measurement electrode 44 is covered with a fourth diffusion control part 45.

The fourth diffusion control part 45 is a film formed of a porous body containing alumina (Al₂O₃) as a main component. The fourth diffusion control part 45 plays a role in limiting the amount of NOx flowing into the measurement electrode 44, and also functions as a protective film (measurement electrode protective layer) of the measurement electrode 44.

The measurement pump cell 41 can pump out oxygen generated through decomposition of nitrogen oxides in the atmosphere around the measurement electrode 44, and detect the amount of generated oxygen as a pump current Ip2.

In order to detect the oxygen partial pressure around the measurement electrode 44, the second solid electrolyte layer 6, the spacer layer 5, the first solid electrolyte layer 4, the third substrate layer 3, the measurement electrode 44, and the reference electrode 42 constitute an electrochemical sensor cell, namely, a measurement-pump-control oxygen-partial-pressure detection sensor cell 82. A variable power supply 46 is controlled based on electromotive force V2 detected by the measurement-pump-control oxygen-partial-pressure detection sensor cell 82.

The measurement gas introduced into the second internal space 40 reaches the measurement electrode 44 through the fourth diffusion control part 45 under a condition in which the oxygen partial pressure is controlled. Nitrogen oxides in the measurement gas around the measurement electrode 44 are reduced (2NO→N₂+O₂) to generate oxygen. The generated oxygen is pumped by the measurement pump cell 41, and, at that time, a voltage Vp2 of the variable power supply 46 is controlled so that a control voltage V2 detected by the measurement-pump-control oxygen-partial-pressure detection sensor cell 82 is kept constant. The amount of oxygen generated around the measurement electrode 44 is proportional to a nitrogen oxide concentration in the measurement gas, and thus the NOx concentration in the measurement gas can be calculated using the pump current Ip2 in the measurement pump cell 41.

If the measurement electrode 44, the first solid electrolyte layer 4, the third substrate layer 3, and the reference electrode 42 are combined to constitute an oxygen partial pressure detection means as an electrochemical sensor cell, electromotive force in accordance with a difference between the amount of oxygen generated through reduction of a NOx component in the atmosphere around the measurement electrode 44 and the amount of oxygen contained in reference atmospheric air can be detected, and the NOx concentration in the measurement gas can thereby be obtained.

The second solid electrolyte layer 6, the spacer layer 5, the first solid electrolyte layer 4, the third substrate layer 3, the outer pump electrode 23, and the reference electrode 42 constitute an electrochemical sensor cell 83, and oxygen partial pressure in the measurement gas outside the sensor can be detected using electromotive force Vref obtained by the sensor cell 83.

A portion of the sensor element 101 extending from the gas inlet 10 to the second internal space 40 in the longitudinal direction of the element, and further, the electrodes, the pump cells, the sensor cells, and the like provided in the portion, which are described above, relate mainly to measurement of the NOx concentration based on a limiting current scheme, and thus they are collectively referred to as a NOx sensor part of the sensor element 101 in the present embodiment.

On the other hand, in the sensor element 101, the outer pump electrode 23 is formed to have catalytic activity inactivated for the HC gas as described above. In the sensor element 101, the outer pump electrode 23, the reference electrode 42, and the solid electrolyte layer between the outer pump electrode 23 and the reference electrode 42 constitute a mixed potential cell 61. This means that, in the gas sensor 100, a HC concentration in the measurement gas can be obtained using a potential difference occurring due to the difference in HC concentration around the outer pump electrode 23 and around the reference electrode 42 based on the principle of mixed potential. The sensor element 101, however, is required to meet a predetermined temperature condition to suitably determine the HC concentration. In the present embodiment, portions of the sensor element 101 constituting the mixed potential cell 61 are collectively referred to as a HC sensor part. The reference electrode 42 is used not only by the HC sensor part but also by the NOx sensor part as described above, and is thus also referred to as a common reference electrode.

More specifically, in the sensor element 101, with an Au abundance ratio on the surfaces of Pt—Au alloy particles included in the outer pump electrode 23 being suitably set, the outer pump electrode 23 is provided to have noticeable dependence of the potential on the HC concentration in a concentration range of 0 ppm to 500 ppm, and at least in a concentration range of 0 ppm to 100 ppm.

In this specification, the Au abundance ratio means an area ratio of a portion covered with Au to a portion at which Pt is exposed in the surface of noble metal particles included in the outer pump electrode 23. In this specification, the Au abundance ratio is calculated from an expression shown below using Au and Pt detection values in an Auger spectrum obtained by performing Auger electron spectroscopy (AES) analysis on the surface of the noble metal particles.

Au abundance ratio=Au detection value/Pt detection value (1)

The Au abundance ratio is one when the area of the portion at which Pt is exposed and the area of the portion covered with Au are equal to each other.

Specifically, the potential of the outer pump electrode 23 exhibits noticeable dependence on the HC concentration in a concentration range of 0 ppmC to 4,000 ppmC when the Au abundance ratio of the outer pump electrode 23 is 0.25 or more and 2.30 or less. The outer pump electrode 23 can be provided to have an Au abundance ratio more than 2.30, but such an outer pump electrode 23 is undesirable because the outer pump electrode 23 is easily degraded in use of the gas sensor 100 due to its high content of Au, whose melting point (1,064° C.) is close to 900° C. as an upper limit of a second element control temperature described below.

The Au abundance ratio can also be calculated using a relative sensitivity coefficient method from a peak intensity of a peak detected for Au and Pt obtained by subjecting the surface of the noble metal particles to X-ray photoelectron spectroscopy (XPS) analysis. The value of the Au abundance ratio obtained by this method can be considered to be substantially the same as the value of the Au abundance ratio calculated based on the result of AES analysis.

The Au abundance ratio expressed by the expression (1) can be considered for an electrode other than the outer pump electrode 23. In particular, the inner pump electrode 22 and the auxiliary pump electrode 51 are preferably provided to have an Au abundance ratio of 0.01 or more and 0.3 or less. In this case, the catalytic activity of the inner pump electrode 22 and the auxiliary pump electrode 51 is reduced for a substance other than oxygen to increase selective decomposing ability for oxygen. The Au abundance ratio is more preferably 0.1 or more and 0.25 or less, and is much more preferably 0.2 or more and 0.25 or less.

On the other hand, the reference electrode 42 is covered with the atmospheric air introduction layer 48 leading to the reference gas introduction space 43 as described above, and thus the surrounding of the reference electrode 42 is always filled with atmospheric air (oxygen) in use of the gas sensor 100. The reference electrode 42 thus always has a constant potential in use of the gas sensor 100.

Thus, when using the gas sensor 100, a potential difference (electromotive force) EMF occurs in the mixed potential cell 61 with stability between the outer pump electrode 23 and the reference electrode 42, which is located inside the atmospheric air introduction layer 48 and is in contact with atmospheric air always having a constant oxygen concentration, in accordance with the HC concentration in the measurement gas at least in a HC concentration range of 0 ppmC to 4,000 ppmC.

Moreover, because the NOx sensor part and the HC sensor part share the reference electrode 42 in the gas sensor 100, simplified internal configuration of the sensor element 101 and space-saving are achieved compared with a conventional multi-gas sensor in which these sensor parts have respective reference electrodes.

The sensor element 101 further includes a heater part 70 playing a role in temperature adjustment of heating the sensor element 101 and keeping it warm to enhance the oxygen ion conductivity of the solid electrolytes. The heater part 70 includes a heater electrode 71, a heater 72, a through hole 73, a heater insulating layer 74, and a pressure diffusion hole 75. The heater electrode 71 is an electrode formed to be in contact with a lower surface of the first substrate layer 1. The heater electrode 71 is to be connected to an external power supply to enable the heater part 70 to be externally powered.

The heater 72 is an electric resistor formed to be vertically sandwiched between the second substrate layer 2 and the third substrate layer 3. The heater 72 is connected to the heater electrode 71 via the through hole 73, and generates heat by being externally powered through the heater electrode 71 to heat the solid electrolytes forming the sensor element 101 and keep it warm.

The heater 72 is buried across the entire region extending from the first internal space 20 to the second internal space 40, and can thereby adjust the sensor element 101 as a whole to a temperature at which the above-mentioned solid electrolytes are activated.

The heater insulating layer 74 is an insulating layer formed of an insulator, such as alumina, on upper and lower surfaces of the heater 72. The heater insulating layer 74 is formed for electrical insulation between the second substrate layer 2 and the heater 72 and for electrical insulation between the third substrate layer 3 and the heater 72.

The pressure diffusion hole 75 is a part provided to penetrate the third substrate layer 3 to communicate with the reference gas introduction space 43, and is formed to mitigate an internal pressure rise associated with a temperature rise in the heater insulating layer 74.

In the gas sensor 100, when the NOx sensor part and the HC sensor part respectively obtain the NOx concentration and the HC concentration, each part is heated to a temperature suitable for operation and kept warm with the generation of heat in the heater 72. This means that, at the location of each of the pump cells, the sensor cells, and the mixed potential cell 61, they are heated to a temperature suitable for operation.

A temperature range suitable for operation, however, differs among them. Specifically, the HC sensor part suitably operates when the HC sensor part is heated to a first temperature (first element control temperature) that is a predetermined temperature of 400° C. or higher and 650° C. or lower. On the other hand, the NOx sensor part suitably operates when the NOx sensor part is heated to a second temperature (the second element control temperature) that is a predetermined temperature of 600° C. or higher and 900° C. or lower, and is higher than the first temperature.

Thus, in the gas sensor 100, the heater 72 heats the sensor element 101 (more specifically, the mixed potential cell 61 constituting the HC sensor part and a portion around the mixed potential cell 61) to the first element control temperature to operate the HC sensor part. On the other hand, the heater 72 heats the sensor element 101 (more specifically, a part (a left part in FIG. 1) being closer to the distal end portion than the third diffusion control part 30 is, which comprises the main pump cell 21 including the inner pump electrode 22 and the outer pump electrode 23 constituting the NOx sensor part) to the second element control temperature to operate the NOx sensor part. The location of each cell, a presence range of the heater, and the details of heating control performed by the heater 72 are set to suitably achieve heating described above.

This means that, despite having similar components to a conventional limiting current NOx sensor, the gas sensor 100 according to the present embodiment can selectively perform measurement of the NOx concentration and measurement of the HC concentration by only changing the control temperature of the sensor element 101. In other words, the gas sensor 100 according to the present embodiment is constituted so that it can selectively perform measurement of the NOx concentration and measurement of the HC concentration, by only changing the composition of the outer pump electrode 23 without providing, to the conventional NOx sensor, an additional component functioning as the HC sensor. That is, in the present embodiment, the gas sensor that can selectively perform measurement of the NOx concentration and measurement of the HC concentration is achieved without complicating the configuration of the conventional NOx sensor.

A mode in which the gas sensor 100 is used as the HC sensor by heating the sensor element 101 to the first element control temperature is hereinafter referred to as a HC mode, and a mode in which the gas sensor 100 is used as the NOx sensor by heating the sensor element 101 to the second element control temperature is hereinafter referred to as a NOx mode.

The sensor element 101 may include a surface protective layer (not illustrated) located on the upper surface of the second solid electrolyte layer 6 to cover the outer pump electrode 23. The surface protective layer is provided for prevention of adhesion of a poisoning substance contained in the measurement gas to the outer pump electrode 23. The surface protective layer is preferably formed of porous alumina, for example. The surface protective layer is provided to have a pore diameter and a pore size not controlling gas distribution between the outer pump electrode 23 and the outside of the element.

Operation of each part of the gas sensor 100, for example, application of voltages to the pump cells performed by the variable power supplies and heating performed by the heater 72, is controlled by a controller (controlling means) 102 electrically connected to each part. In addition, the controller 102 determines the NOx concentration in the measurement gas based on the pump current Ip2 flowing through the measurement pump cell 41. The controller 102 determines the HC concentration in the measurement gas based on the electromotive force EMF occurring in the mixed potential cell 61 of the sensor element 101. This means that the controller 102 functions as a concentration determination means for determining the NOx concentration and further determining the HC concentration. Although only a symbol of the electromotive force EMF and a symbol of the pump current Ip2 are connected to the controller 102 by arrows in FIG. 1 for clarity of illustration, it is needless to say that other values of the potential difference and values of the pump current are also provided to the controller 102. A general-purpose personal computer is applicable to the controller 102.

<Process of Manufacturing Sensor Element>

The process of manufacturing the sensor element 101 illustrated in FIG. 1 will be described next. Generally speaking, the sensor element 101 illustrated in FIG. 1 is manufactured by forming a laminated body formed of green sheets containing an oxygen-ion conductive solid electrolyte, such as zirconia, as a ceramic component, and by cutting and firing the laminated body. The oxygen-ion conductive solid electrolyte is, for example, yttrium partially stabilized zirconia (YSZ) obtained by internally adding, to zirconia, yttria at a proportion of 3 mol % or more.

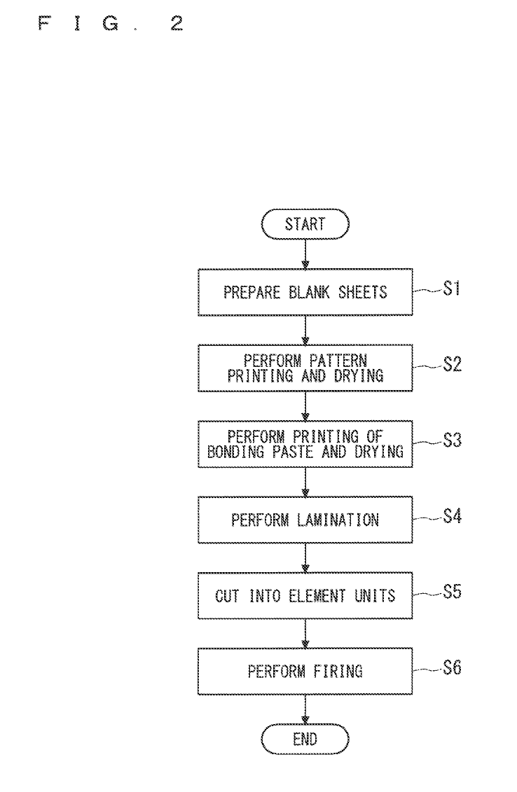

FIG. 2 shows a processing flow in the manufacture of the sensor element 101. In the manufacture of the sensor element 101, blank sheets (not illustrated) that are green sheets having no pattern formed thereon are prepared first (step S1). Specifically, six blank sheets corresponding to the first substrate layer 1, the second substrate layer 2, the third substrate layer 3, the first solid electrolyte layer 4, the spacer layer 5, and the second solid electrolyte layer 6 are prepared. The blank sheets have a plurality of sheet holes used for positioning in printing and lamination. The sheet holes are formed in advance through, for example, punching by a punching machine. Green sheets corresponding to layers forming an internal space also include penetrating portions corresponding to the internal space formed in advance through, for example, punching as described above. The blank sheets corresponding to the respective layers of the sensor element 101 are not required to have the same thickness.

After preparation of the blank sheets corresponding to the respective layers, pattern printing and drying are performed to form various patterns on the individual blank sheets (step S2). Specifically, the electrode pattern of each pump electrode, the pattern of the heater 72, the atmospheric air introduction layer 48, internal wiring (not illustrated), and the like are formed. The pattern of the surface protective layer may further be printed. With respect to the first substrate layer 1, a cut mark serving as a reference cut position when the laminated body is cut in a subsequent step is printed.

Each pattern is printed by applying, to the blank sheet, a paste for pattern formation prepared in accordance with the characteristics required for each formation target using a known screen printing technique. Any known drying means is available for drying after printing.

After pattern printing, printing of a bonding paste and drying are performed to laminate and bond the green sheets corresponding to the respective layers (step S3). Any known screen printing technique is available for printing of the bonding paste, and any known drying means is available for drying after printing.

Then, the green sheets to which an adhesive has been applied are stacked in a predetermined order, and the stacked green sheets are crimped under predetermined temperature and pressure conditions to thereby form a laminated body (step S4). Specifically, crimping is performed by stacking and holding the green sheets as a target of lamination in a predetermined lamination jig (not illustrated) while positioning the green sheets at the sheet holes, and then heating and pressurizing the green sheets together with the lamination jig using a lamination machine, such as a known hydraulic pressing machine. The pressure, temperature, and time for heating and pressurizing depend on a lamination machine to be used, and these conditions may be set appropriately to achieve good lamination. The surface protective layer may be formed on the laminated body as obtained.

After the laminated body is obtained as described above, the laminated body is cut out at a plurality of positions to obtain individual units (referred to as element bodies) of the sensor element 101 (step S5). The cut out element bodies are fired under predetermined conditions, thereby producing the sensor element 101 as described above (step S6). This means that the sensor element 101 is produced by integral firing (co-firing) of the solid electrolyte layers and the electrodes. The firing temperature is preferably 1,200° C. or higher and 1,500° C. or lower (e.g., 1,400° C.). Integral firing performed in such a manner provides sufficient adhesion strength to each of the electrodes of the sensor element 101. This contributes to improvement in durability of the sensor element 101.

The sensor element 101 thus obtained is housed in a predetermined housing, and incorporated into a main body (not illustrated) of the gas sensor 100.

The paste for pattern (a conductive paste) used to form the outer pump electrode 23 by printing can be produced by using an Au ion-containing liquid as an Au starting material and mixing the Au ion-containing liquid with powdered Pt, powdered zirconia, and a binder. Any binder, which can disperse any other raw material to the printable extent and vanishes through firing, may be appropriately selected.

The Au ion-containing liquid is obtained by dissolving a salt containing an Au ion or an organometallic complex containing an Au ion in a solvent. The Au ion-containing salt may be, for example, tetrachloroauric(III) acid (HAuCl₄), sodium chloroaurate(III) (NaAuCl₄), or potassium dicyanoaurate(I) (KAu(CN)₂). The Au ion-containing organometallic complex may be, for example, gold(III) diethylenediamine trichloride ([Au(en)₂]Cl₃), gold(III) dichloro(1,10-phenanthroline)chloride ([Au(phen)Cl₂]Cl), dimethyl(trifluoroacetylacetonate)gold, or dimethyl(hexafluoroacetylacetonate)gold. Tetrachloroauric(III) acid or gold(III) diethylenediamine chloride ([Au(en)₂]Cl₃) is preferably used from the viewpoint of no impurity such as Na or K remaining in the electrode, easy handling, or dissolvability in the solvent. The solvent may be acetone, acetonitrile, or formamide as well as alcohols such as methanol, ethanol, and propanol.

Mixing can be performed by well-known means such as instillation. Although the obtained conductive paste contains Au present in ionic (complex ionic) state, the outer pump electrode 23 formed in the sensor element 101 obtained through the above-mentioned manufacturing process contain Au mainly as an elemental substrate or an alloy with Pt.

Alternatively, the conductive paste for the outer pump electrode 23 may be prepared by using coated powder, which is obtained by coating powdered Pt with Au, as a starting raw material, instead of preparing the paste through liquid-state Au mixing as described above. In such a case, a conductive paste for the outer pump electrode is prepared by mixing the coated powder, zirconia powder, and a binder. Here, the coated powder may be obtained by covering the particle surface of powdered Pt with an Au film or applying Au particles to Pt powder particles.

<Application to Engine System>

An example of application of the above-mentioned gas sensor 100 to a diesel engine system (hereinafter, also simply referred to as an engine system) including a diesel oxidation catalyst (DOC, hereinafter also referred to as an oxidation catalyst) will be described next.

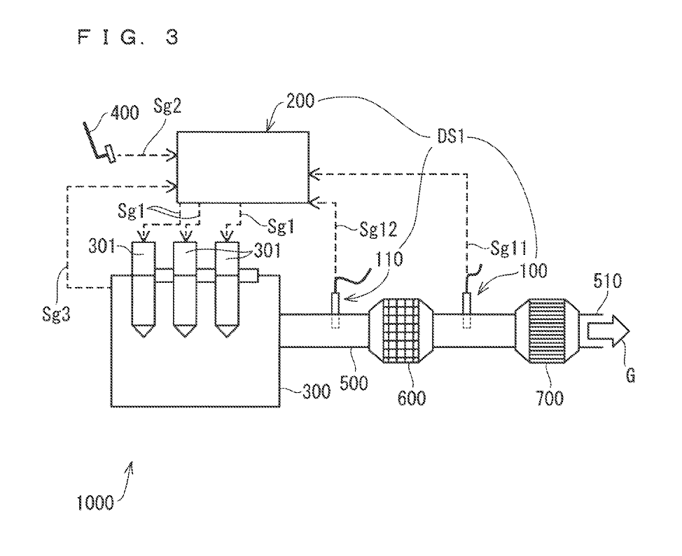

FIG. 3 schematically illustrates a configuration of an engine system 1000 including an oxidation catalyst diagnosis system DS1 comprising the gas sensor 100.

The oxidation catalyst diagnosis system DS1 mainly includes the gas sensor 100, a temperature sensor 110, and an electronic controller 200 that is a controller for controlling an operation of the entire engine system 1000.

The engine system 1000 includes, in addition to the oxidation catalyst diagnosis system DS1, an engine main body 300 that is a diesel engine of one type of internal combustion engine, a plurality of fuel injection valves 301 that inject a fuel into the engine main body 300, a fuel injection instruction part 400 for instructing the fuel injection valves 301 to inject a fuel, an exhaust pipe 500 forming an exhaust path that externally discharges an exhaust gas (engine exhaust) G generated in the engine main body 300, and an oxidation catalyst 600 such as platinum or palladium that is provided at some midpoint of the exhaust pipe 500 and oxidizes or adsorbs an unburned HC gas in the exhaust gas G. In the present embodiment, in a relative meaning, the position closer to the engine main body 300 that is one side of the exhaust pipe 500 is referred to an upstream side, and the position closer to an exhaust port 510 that is opposite the engine main body 300 is referred to as a downstream side.

The engine system 1000 is typically mounted in a vehicle, and in such a case, the fuel injection instruction part 400 is an accelerator pedal.

In the engine system 1000, the electronic controller 200 issues a fuel injection instruction signal sg1 to the fuel injection valves 301. The fuel injection instruction signal sg1 is usually issued in response to a fuel injection request signal sg2 for demanding an injection of a predetermined amount of fuel, which is provided from the fuel injection instruction part 400 to the electronic controller 200 during the operation (action) of the engine system 1000 (e.g., an accelerator pedal is depressed so that an optimum fuel injection reflecting a large number of parameters, such as the position of an accelerator, an amount of oxygen intake, an engine speed, and torque is demanded). In addition to this, a fuel injection instruction signal sg1 may be issued for the oxidation catalyst diagnosis system DS1 to operate.

A monitor signal sg3 for monitoring various situations inside the engine main body 300 is provided from the engine main body 300 to the electronic controller 200.

The electronic controller 200 includes storage (not shown) such as memory or HDD, and the storage stores a program for controlling the operations of the engine system 1000 and the oxidation catalyst diagnosis system DS1, and also stores threshold data used to diagnose the degree of degradation of the oxidation catalyst 600 described below.

In the engine system 1000, the exhaust gas G exhausted from the engine main body 300 that is a diesel engine is a gas in an excessive oxygen (O₂) atmosphere having an oxygen concentration of approximately 10%. Specifically, such an exhaust gas G contains oxygen and unburned HC gas, and also contains NOx, soot (graphite), and the like. In this specification, an unburned HC gas contains not only typical hydrocarbon gases (classified as hydrocarbons by a chemical formula) such as C₂H₄, C₃H₆, and n-C8, but also carbon monoxide (CO). The gas sensor 100 can preferably detect a target gas, including CO. However, CH₄ is excluded.

The engine system 1000 may include one or a plurality of purification devices 700 at some midpoint of the exhaust pipe 500, in addition to the oxidation catalyst 600.

The oxidation catalyst diagnosis system DS1 is targeted for a diagnosis of a degree of degradation of the oxidation catalyst 600 (more specifically, a degree of degradation in the catalytic ability of the oxidation catalyst 600). The oxidation catalyst 600 is provided to adsorb or oxide an unburned HC gas and a NOx in the exhaust gas G that has flowed from the upstream side to prevent the unburned HC gas and NOx from flowing out through the exhaust port 510 at the end of the exhaust pipe 500, but its catalytic ability (specifically, adsorbing capability and oxidizing capability) degrades with time. The occurrence of such degradation is not preferable because it increases an amount of the unburned HC gas and NOx that are not captured by the oxidation catalyst 600 but flows downstream.

In the oxidation catalyst diagnosis system DS1, the electronic controller 200 is configured to diagnose whether the oxidation catalyst 600 has degraded or not on the basis of a detection signal sg11 issued from the gas sensor 100 and an exhaust temperature detection signal sg12 issued from the temperature sensor 110.

The gas sensor 100 is located downstream from the oxidation catalyst 600 along the exhaust pipe 500, and detects HC or NOx at the location in accordance with the element control temperature. On the other hand, the temperature sensor 110 is located upstream from the oxidation catalyst 600, and detects the temperature of the exhaust gas G (an exhaust temperature) at the location. In the present embodiment, the temperature detected by the temperature sensor 110 is considered as the temperature of the oxidation catalyst 600 in the diagnosis of degradation. One end portion of the gas sensor 100 and one end portion of the temperature sensor 110 have each been inserted in the exhaust pipe 500.

More specifically, the oxidation catalyst diagnosis system DS1 can determine a light-off timing of the oxidation catalyst 600 based on an output (the detection signal sg11) from the gas sensor 100 during from starting of the engine system 1000 until reaching to steady-state operation. Based on an output (the exhaust temperature detection signal sg12) from the temperature sensor 110 at the light-off timing, a light-off temperature of the oxidation catalyst 600 can be determined. Based on the level of the light-off temperature, the degree of degradation of the catalytic ability of the oxidation catalyst 600 can further be diagnosed.

Herein, light-off of the oxidation catalyst 600 refers to that the oxidation catalyst 600, which has a temperature approximately equal to the temperature of atmospheric air when the engine main body 300 is stopped, starts demonstrating the oxidizing ability through heating by the exhaust gas G generated in the engine main body 300 cold-started upon key-on of the engine system 1000, and the light-off temperature refers to the temperature when the oxidation catalyst 600 has reached light-off.

The oxidation catalyst 600 does not oxidize the unburned HC gas in the exhaust gas G when being at a temperature lower than the light-off temperature, and thus most of the unburned HC gas in the exhaust gas G generated by the engine main body 300 is discharged downstream as it is, though a certain part of it is adsorbed by the oxidation catalyst 600. Once the oxidation catalyst 600 has reached the light-off temperature through heating by the exhaust gas G, the oxidation catalyst 600 starts demonstrating the oxidizing ability to oxidize the unburned HC gas in the exhaust gas G, and thus the amount of unburned HC gas discharged downstream decreases. By monitoring the concentration of the unburned HC gas at the location downstream from the oxidation catalyst 600 after key-on of the engine system 1000, a timing at which the concentration varies noticeably can be identified as the light-off timing. By additionally monitoring the temperature of the oxidation catalyst 600, the temperature of the oxidation catalyst 600 at the light-off timing can be identified as the light-off temperature.

It is empirically known that the light-off temperature increases as increasing accumulated time of use of the oxidation catalyst 600. The degree of degradation of the oxidation catalyst 600 can thus be known by determining the light-off temperature.

The gas sensor 100 according to the present embodiment can be used in the HC mode in which the concentration of the unburned HC gas can be determined, and can thus suitably be used to determine the light-off temperature.

In addition, when the engine system 1000 operates in a steady state after determination of the light-off temperature, the gas sensor 100 according to the present embodiment can measure (monitor) the NOx concentration at the location downstream from the oxidation catalyst 600 with the usage in the NOx mode. This means that the gas sensor 100 according to the present embodiment can perform different functions in different situations, even though the gas sensor 100 is a single sensor.

Any known temperature sensor used in a typical engine system to measure the exhaust temperature may be used as the temperature sensor 110.

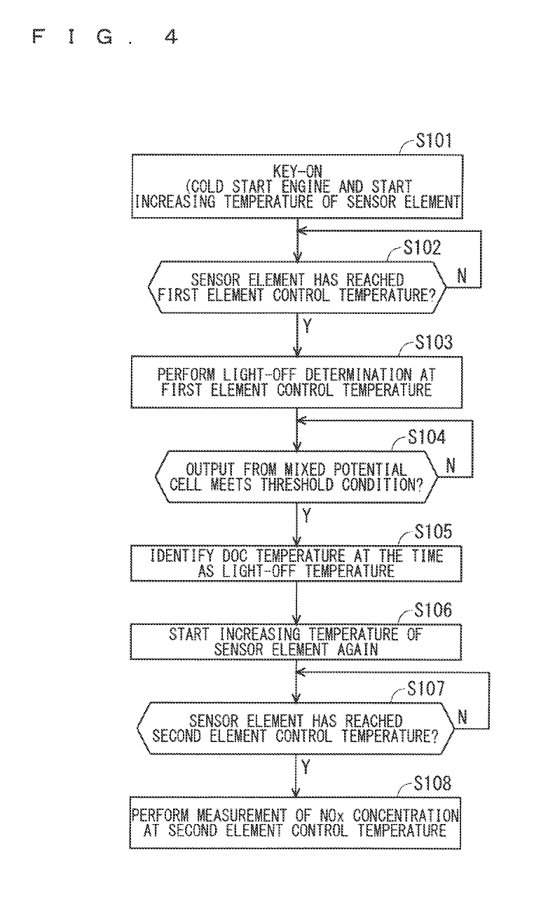

FIG. 4 shows a specific example of a processing flow in the oxidation catalyst diagnosis system DS1 when the engine system 1000 is started.

Upon key-on of the engine system 1000 being in a stopped state and therefore the oxidation catalyst 600 included therein having a temperature approximately equal to the temperature of atmospheric air, the engine main body 300 is cold started (step S101). Accordingly, the exhaust gas G is generated in the engine main body 300. The exhaust gas G reaches the oxidation catalyst 600 through the exhaust pipe 500, and starts heating the oxidation catalyst 600.

The oxidation catalyst diagnosis system DS1 also starts operation when the engine system 1000 is started upon key-on. In the gas sensor 100 as one component of the oxidation catalyst diagnosis system DS1, the heater 72 starts heating the sensor element 101 to increase the temperature of the sensor element 101. The temperature of the sensor element 101 is increased until at least the HC sensor part of the sensor element 101 reaches the first element control temperature, which is a predetermined temperature of 400° C. or higher and 650° C. or lower and at which the HC sensor part suitably operates, to enable the gas sensor 100 to be used in the HC mode (NO in step S102). The heating of the sensor element 101 to the first element control temperature by the heater 72 is controlled so that it is achieved sufficiently earlier than the oxidation catalyst 600 reaches the light-off temperature.

When the sensor element 101 has reached the first element control temperature (YES in step S102), the electronic control apparatus 200 starts performing light-off determination to determine the light-off temperature of the oxidation catalyst 600 (step S103). The sensor element 101 is hereinafter maintained at the first element control temperature until identification of the light-off temperature described below. In this case, the contents of the detection signal sg11 emitted from the gas sensor 100 being in the HC mode correspond to a value of the electromotive force EMF occurring in the mixed potential cell 61 of the HC sensor part.

Specifically, the electronic control apparatus 200 continuously or intermittently obtains the detection signal sg11 from the gas sensor 100, and obtains the exhaust temperature detection signal sg12 from the temperature sensor 110 in matching a timing at which the detection signal sg11 is obtained. The temperature determined from the exhaust temperature sensing signal sg12 at the time is considered as the temperature of the oxidation catalyst 600 (a DOC temperature) when the exhaust temperature detection signal sg12 is obtained.

The electronic control apparatus 200 determines whether the output value from the mixed potential cell 61 as obtained meets a predetermined threshold condition stored in advance as the threshold data in order to judge whether the concentration of the unburned HC gas varies noticeably at the location downstream from the oxidation catalyst 600 (step S104). If the output value from the mixed potential cell 61 fails to meet the threshold condition (NO in step S104), the determination is repeatedly performed since the oxidation catalyst 600 has not reached light-off.

The specific threshold condition may be set as appropriate as long as the light-off temperature is suitably determined based on the concentration fluctuation of the unburned HC gas. For example, the threshold condition may be set to be met when the output value from the mixed potential cell 61 is equal to or smaller than a predetermined absolute value, or may be set to be met when a difference value (amount of change), from an initial value or the output value obtained at a previous timing, of the output value continuously or intermittently obtained by the electronic control apparatus 200 is equal to or greater than a predetermined value.

When the output value from the mixed potential cell 61 meets the threshold condition (YES in step S104), it is determined that the oxidation catalyst 600 has reached light-off. The temperature determined from the exhaust temperature detection signal sg12 at the time is identified as the light-off temperature (step S105). The degree of degradation of the oxidation catalyst 600 is diagnosed based on the light-off temperature as identified.

Upon identification of the light-off temperature, the temperature of the sensor element 101 is started to be increased again (step S106). The temperature of the sensor element 101 is increased until the sensor element 101 reaches the second element control temperature, which is a predetermined temperature of 600° C. or higher and 900° C. or lower, and is higher than the first temperature (NO in step S107).

When the sensor element 101 has reached the second element control temperature (YES in step S107), the NOx sensor part of the sensor element 101 starts performing continuous measurement (monitoring) of the NOx concentration (step S108). The sensor element 101 is hereinafter maintained at the second element control temperature during operation of the engine system 1000.

As described above, in the present embodiment, the sensor element of the gas sensor includes the NOx sensor part functioning as a limiting current NOx sensor and the HC sensor part functioning as a mixed potential HC sensor. In addition, an electrode functioning as the outer pump electrode in the NOx sensor part is provided as a cermet electrode formed of zirconia and a Pt—Au alloy having an Au abundance ratio of 0.25 or more and 2.30 or less so as to be also used as a sensing electrode for generating a mixed potential in the HC sensor part, and further, the reference electrode is shared by the NOx sensor part and the HC sensor part. According to the present embodiment, a gas sensor (multi-gas sensor) functioning as the HC sensor and as the NOx sensor by only changing the control temperature is achieved without complicating the configuration of the conventional NOx sensor.

In a case where the gas sensor is located downstream from the oxidation catalyst included in the engine system, the gas sensor is set to the HC mode at starting of the engine system by heating the sensor element to the first element control temperature at which the HC sensor part suitably operates, and change of the output value from the gas sensor is monitored, so that the light-off timing of the oxidation catalyst is determined based on the change of the output value. The light-off temperature of the oxidation catalyst can be determined based on the output from the temperature sensor at the light-off timing. Furthermore, the degree of degradation of the oxidation catalyst can be diagnosed from level of the light-off temperature.

After diagnosis, the sensor element is heated to the second element control temperature at which the NOx sensor part suitably operates, and the NOx concentration is monitored at the location downstream from the oxidation catalyst in the engine system operating in a steady state. Accordingly, in the present embodiment, with a usage of a gas sensor including the HC sensor part and the NOx sensor part and being capable of being selectively used in the HC mode and in the NOx mode, while having similar configuration to a conventional NOx sensor, diagnosis of degradation of the oxidation catalyst in the HC mode at starting of the engine system and monitoring of the NOx concentration in the NOx mode during steady-state operation are performed respectively.

### EXAMPLES

### Example 1

In this Example, whether oxygen pumping ability of each pump cell including the outer pump electrode 23 was affected by providing the outer pump electrode 23 so as to also function as the sensing electrode of the mixed potential cell 61 was confirmed.

Specifically, the gas sensor 100 was manufactured to include the outer pump electrode 23 containing the Pt—Au alloy having an Au abundance ratio of 1.05, and a functional relationship (sensitivity characteristics) between a NO concentration and the pump current Ip2 in the NOx sensor part was evaluated using model gases under conditions shown below. The temperature (second element control temperature) of the sensor element 101 was set to 800° C.

[Model Gas Conditions]

Flow rate: 200 L/min;

Gas temperature: 120° C.; and

Gas Composition:

O₂=10%;

H₂O=5%;

NO=0 ppm, 100 ppm, 200 ppm, 300 ppm, 400 ppm, or 500 ppm; and

N₂=balance.

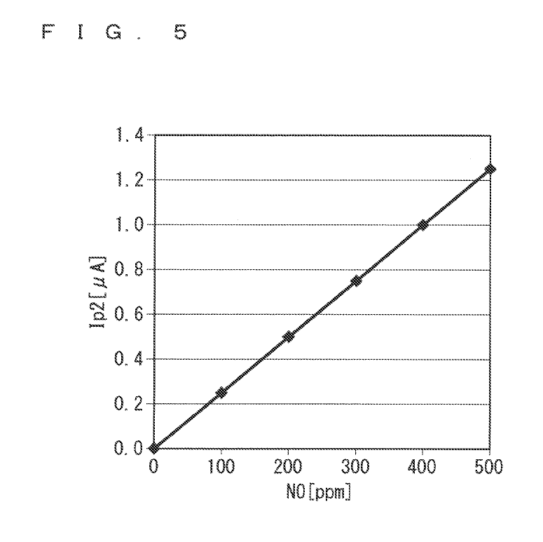

FIG. 5 shows the sensitivity characteristics as obtained. It can be seen from FIG. 5 that the NO concentration and the pump current Ip2 are proportional to each other. It was thus confirmed that, in the gas sensor 100, the NOx sensor part had favorable sensitivity characteristics though the NOx sensor part shared the outer pump electrode 23 with the HC sensor part.

Although this evaluation is targeted directly at the oxygen pumping ability of the measurement pump cell 41, in order to obtain the favorable sensitivity characteristics, it is required in the first place not only that the measurement pump cell 41 favorably operates but also that oxygen in the measurement gas is to be sufficiently pumped out before the measurement gas reaches the measurement electrode 44, by suitably operating the main pump cell 21 and the auxiliary pump cell 50 both sharing the outer pump electrode 23 with the measurement pump cell 41. The results shown in FIG. 5 thus indirectly means that the outer pump electrode 23 suitably operates not only in the measurement pump cell 41 but also in the main pump cell 21 and in the auxiliary pump cell 50.

### Example 2

In this Example, whether degradation of the oxidation catalyst 600 could be diagnosed based on the light-off temperature of the oxidation catalyst 600, using the oxidation catalyst diagnosis system DS1 including the gas sensor 100, was confirmed. Specifically, three types of the oxidation catalyst 600 having different degrees of degradation were each attached to the engine system 1000 shown in FIG. 3, the engine main body 300 was cold started upon key-on of the engine system 1000, and a change over time of each of the output from the mixed potential cell 61, which was the output from the gas sensor 100 being in the HC mode, and the temperature of the oxidation catalyst 600 determined from the output value from the temperature sensor 110 was examined. The concentration fluctuation of the unburned HC gas in the exhaust gas G was also confirmed at the location upstream from the oxidation catalyst 600 and at the location downstream from the oxidation catalyst 600 by attaching FID analyzers (Bex-5101D from Best Instruments Co., Ltd.) in advance at the respective locations. The validity of identification of the light-off temperature based on the output from the mixed potential cell 61 was evaluated from the results.

A diesel engine having a displacement of 2.0 L was used as the engine main body 300. The outer pump electrode 23 of the sensor element 101 was formed to have an Au abundance ratio of 1.05.

Diagnosis was targeted at three types of the oxidation catalyst 600, namely, a “new” oxidation catalyst that was an unused oxidation catalyst having not been in contact with the exhaust gas G, and an oxidation catalyst “aged at 650° C.” and an oxidation catalyst “aged at 850° C.” that were oxidation catalysts obtained by performing aging on unused oxidation catalysts under different conditions to achieve similar states to used oxidation catalysts having degraded catalytic ability through use.

Table 1 shows the details of aging in a list.

TABLE 1

| | | FLOW | TEMPERATURE | MAXIMUM | | TEMPERATURE |
|---|---|---|---|---|---|---|
| | AGING | RATE | INCREASE | TEMPERATURE | TIME | DECREASE |
| DOC | ATMOSPHERE | (ccm) | RATE (° C./h) | (° C.) | (h) | RATE (° C./h) |
| NEW | (WITHOUT BEING AGED) | | | | | |
| AGED AT | AIR + 10% H₂O | 500 | 200 | 650 | 2 | 200 |
| 650° C. | (HUMIDIFIED | | | | | |
| AGED AT | 46° C.) | | | 850 | 16 | |
| 850° C. | | | | | | |

That is to say, the oxidation catalyst “aged at 650° C.” was obtained by performing aging of keeping the oxidation catalyst 600 originally being an unused oxidation catalyst at a maximum temperature of 650° C. for two hours in a pipe through which an aging atmosphere (a humidified atmosphere) including air (atmospheric air) to which H₂O had been added at 46° C. at a volume ratio of 10% flowed at a flow rate of 500 ccm. A rate at which the temperature was increased from room temperature to 650° C. and a rate at which the temperature was decreased from 650° C. to room temperature were each set to 200° C./h.

On the other hand, the oxidation catalyst “aged at 850° C.” was obtained by performing aging on the oxidation catalyst 600 originally being an unused oxidation catalyst under the same conditions as the oxidation catalyst “aged at 650° C.” except that the oxidation catalyst 600 was kept at a maximum temperature of 850° C. for 16 hours.

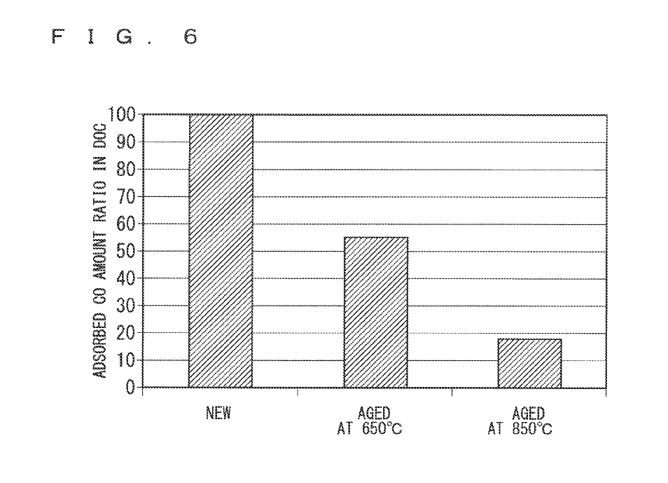

FIG. 6 shows the results of evaluation of the amount of CO adsorbed by CO pulse adsorption, which was performed targeted at samples obtained by pulverizing these oxidation catalysts 600 in order to see the effect of aging. More specifically, FIG. 6 shows a ratio (adsorbed CO amount ratio) relative to the amount of adsorbed CO in the “new” oxidation catalyst 600.

In CO pulse adsorption, one CO molecule is adsorbed on one atom of a noble metal (specifically, Pt) contained in the oxidation catalyst 600, and thus a Pt ratio on the surface of the oxidation catalyst 600 can be measured by measuring the amount of adsorbed CO. That is to say, a smaller amount of adsorbed CO indicates that smaller number of Pt atoms is exposed on the surface, in other words, the oxidation catalyst 600 is degraded more.

According to the results shown in FIG. 6, the adsorbed CO amount ratio is smaller in the oxidation catalyst “aged at 650° C.” than in the “new” oxidation catalyst, and is smaller in the oxidation catalyst “aged at 850° C.” than in the oxidation catalyst “aged at 650° C.”. This means that the oxidation catalyst “aged at 850° C.” is the most degraded oxidation catalyst 600 of the three oxidation catalysts, and the oxidation catalysts then have more degraded catalytic ability in the order of the oxidation catalyst “aged at 650° C.” and the “new” oxidation catalyst.

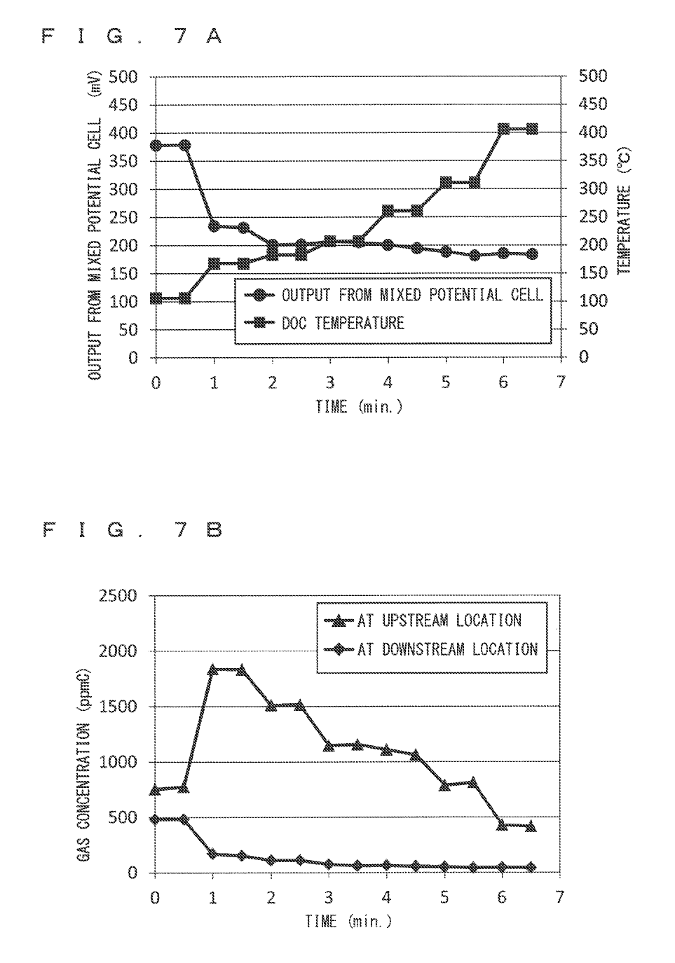

FIGS. 7A and 7B, 8A and 8B, and 9A and 9B show, respectively for the “new” oxidation catalyst, the oxidation catalyst “aged at 650° C.”, and the oxidation catalyst “aged at 850° C.”, (a) the output value from the mixed potential cell 61 and the temperature of the oxidation catalyst (DOC) 600 (FIGS. 7A, 8A, and 9A) and (b) a change over time of the concentration of the unburned HC gas from key-on at the location upstream from the oxidation catalyst 600 and at the location downstream from the oxidation catalyst 600 (FIGS. 7B, 8B, and 9B, more specifically, a change over time of the sum of a total hydrocarbon (THC) concentration and a CO concentration). It actually takes some time for the sensor element 101 to reach the first element control temperature so that the output can be obtained from the mixed potential cell 61 after key-on, but, as the time is short enough to be negligible, the time when the sensor element 101 has reached the first element control temperature will be described as the time of key-on below.

As shown in FIG. 7A, in the “new” oxidation catalyst, the output value from the mixed potential cell falls sharply from an initial value of approximately 380 mV to a value of approximately 230 mV one minute after key-on, and thereafter decreases much more gradually.

As for change of the gas concentration shown in FIG. 7B, the value of the concentration increases sharply one minute after key-on at the upstream location, whereas the value of the concentration decreases significantly (from 500 ppmC to 200 ppmC) one minute after key-on at the downstream location, and thereafter remains almost unchanged. That is to say, the sharp fall in output value from the mixed potential cell 61 shown in FIG. 7A and the decrease in concentration of the unburned HC gas at the location downstream from the oxidation catalyst 600 shown in FIG. 7B coincides with each other.

While the increase in value of the concentration at the upstream location corresponds to an increase in number of rotation and torque of the engine main body 300, it is considered that the start of oxidizing the unburned HC gas existing at the upstream location accompanied by the start of demonstrating the oxidizing ability in the oxidation catalyst 600 results in that the value of the concentration decreases at the downstream location despite such an increase at the upstream location. This presumably meant that to. This means that the “new” oxidation catalyst 600 had reached light-off one minute after key-on.

As the light-off timing coincides with the sharp fall in output value from the mixed potential cell 61, the timing at which the output value from the mixed potential cell 61 decreases to the extent to meet the predetermined threshold condition can be treated as the light-off timing if the output value from the mixed potential cell 61 is measured over time after key-on.

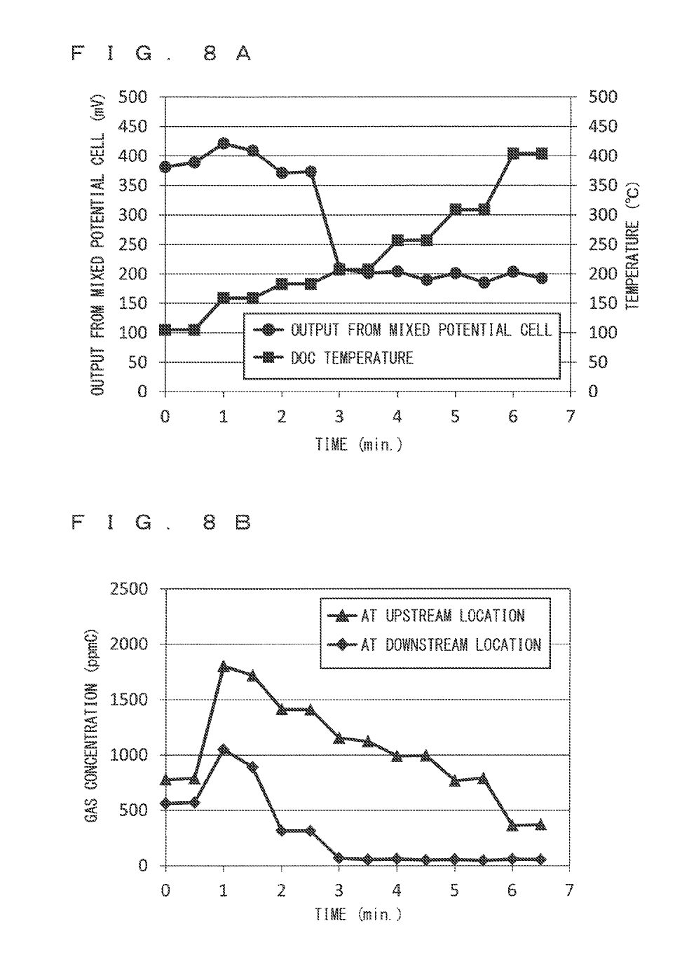

According to FIG. 7A, the temperature of the oxidation catalyst 600 at the time is approximately 170° C., and thus the light-off temperature of the “new” oxidation catalyst 600 is identified as approximately 170° C. This means that the light-off temperature can be identified by measuring over time, in addition to the output value from the mixed potential cell 61, the temperature of the oxidation catalyst 600 after key-on. On the other hand, it is confirmed from FIGS. 8A and 8B showing the results concerning the oxidation catalyst “aged at 650° C.” that the output value from the mixed potential cell 61 decreases (from 330 mV to 200 mV) and the concentration of the unburned HC gas decreases (from 300 ppmC to 100 ppmC or lower) at the location downstream from the oxidation catalyst 600 three minutes after key-on, and both the values thereafter remains almost unchanged. This means that the light-off timing can be obtained from a change over time of the output value from the mixed potential cell 61 as with the “new” oxidation catalyst. Specifically, it is judged that the oxidation catalyst “aged at 650° C.” reaches light-off three minutes after key-on. According to FIG. 8A, the temperature of the oxidation catalyst 600 at the time is approximately 210° C., and thus the light-off temperature is identified as approximately 210° C.

According to FIG. 8B, the concentration of the unburned HC gas at the location downstream from the oxidation catalyst 600 decreases significantly one and a half minutes to two minutes after key-on. The decrease, however, only follows the concentration fluctuation of the unburned HC gas at the location upstream from the oxidation catalyst 600 half a minute to two minutes after key-on, and does not correspond to light-off. As shown in FIG. 8A, the output value from the mixed potential cell 61 also increases and decreases half a minute to two minutes after key-on. This also indicates the validity of determination of the light-off timing based on the decrease in output value from the mixed potential cell 61.

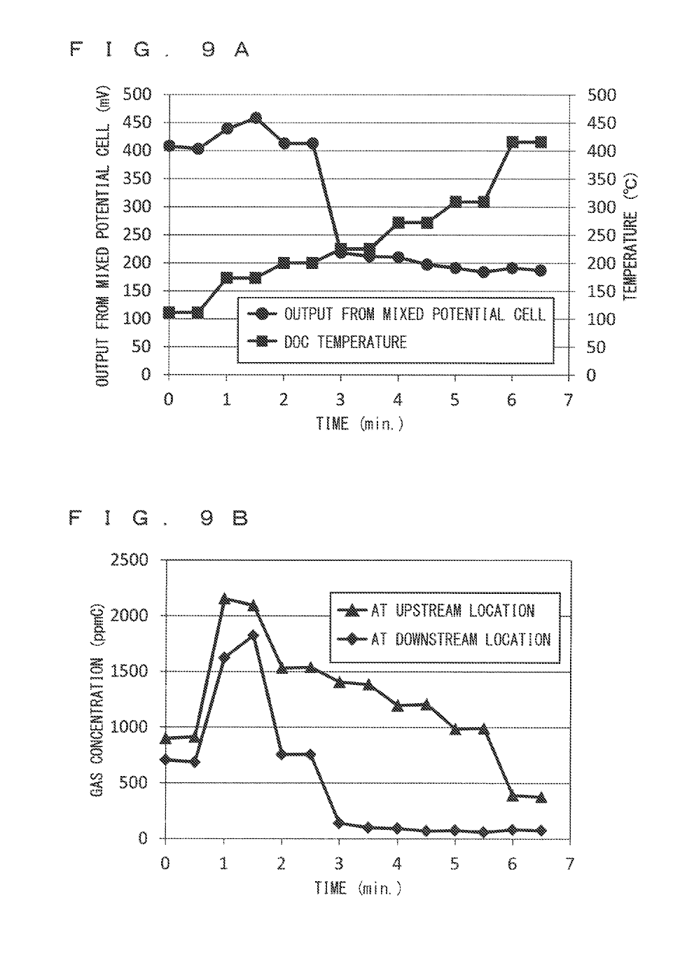

The results concerning the oxidation catalyst “aged at 850° C.” shown in FIGS. 9A and 9B are approximately similar to the results concerning the oxidation catalyst “aged at 650° C.” shown in FIGS. 8A and 8B. That is to say, as for the oxidation catalyst “aged at 850° C.”, the output value from the mixed potential cell 61 decreases sharply (from 410 mV to 220 mV) three minutes after key-on, and thus the oxidation catalyst “aged at 850° C.” is determined to reach light-off at this timing. The concentration of the unburned HC gas at the location downstream from the oxidation catalyst 600 also decreases sharply (from 750 ppmC to 100 ppmC). The light-off temperature, however, is identified as 230° C., which is slightly higher than that of the oxidation catalyst “aged at 650° C.”.

It can be seen from the results shown in FIGS. 7A, 7B, 8A, 8B, 9A, and 9B that the light-off timing of the oxidation catalyst 600 can be determined based on change (the sharp fall) of the output from the gas sensor 100 being in the HC mode (output from the mixed potential cell 61), and the temperature of the oxidation catalyst 600 at the timing can be identified as the light-off temperature.

It can also be seen that more degraded oxidation catalyst 600 (in the order of the “new” oxidation catalyst, the oxidation catalyst “aged at 650° C.”, and the oxidation catalyst “aged at 850° C.”) has higher light-off temperature (in the order of 170° C., 210° C., and 230° C.). This means that the degree of degradation of the oxidation catalyst 600 can be diagnosed based on level of the light-off temperature.

While the invention has been shown and described in detail, the foregoing description is in all aspects illustrative and not restrictive. It is therefore understood that numerous modifications and variations can be devised without departing from the scope of the invention.

What is claimed is:

1. A gas sensor for detecting a predetermined gas component in a measurement gas, said gas sensor comprising:
a sensor element including a lamination of a plurality of oxygen-ion conductive solid electrolyte layers; and
a heater located inside said sensor element to heat said sensor element, wherein
said sensor element includes:
a NOx sensor part; and
a HC sensor part,
said NOx sensor part includes:
at least one internal space into which said measurement gas is introduced from an external space;
a NOx measurement electrode formed to face said at least one internal space;
an outer pump electrode formed on a surface of said sensor element; and
a reference electrode located between two of said plurality of oxygen-ion conductive solid electrolyte layers to be in contact with a reference gas, and
said NOx sensor part has a measurement pump cell that is an electrochemical pump cell constituted by said NOx measurement electrode, said outer pump electrode, and a solid electrolyte between said NOx measurement electrode and said outer pump electrode,
said HC sensor part has a mixed potential cell constituted by said outer pump electrode, said reference electrode, and a solid electrolyte between said outer pump electrode and said reference electrode, said outer pump electrode having catalytic activity inactivated for a hydrocarbon gas and carbon monoxide,
said gas sensor is configured to be capable of selectively performing a HC mode for determining a HC concentration in said measurement gas and a NOx mode for determining a NOx concentration in said measurement gas in accordance with temperature of said sensor element,
in said HC mode, said heater heats at least said HC sensor part of said sensor element to a first temperature which is 400° C. or higher and 650° C. or lower, and said gas sensor determines said HC concentration based on a potential difference occurring between said outer pump electrode and said reference electrode in said mixed potential cell, and
in said NOx mode, said heater heats at least said NOx sensor part of said sensor element to a second temperature which is 600° C. or higher and 900° C. or lower, and is higher than said first temperature, and said gas sensor determines said NOx concentration based on a pump current flowing between said NOx measurement electrode and said outer pump electrode in a state of controlling a voltage applied between said NOx measurement electrode and said outer pump electrode to maintain a potential difference between said NOx measurement electrode and said reference electrode constant.

2. The gas sensor according to claim 1, wherein
said outer pump electrode is formed of a cermet composed of a noble metal and an oxygen-ion conductive solid electrolyte, and
said noble metal is a Pt—Au alloy, and an Au abundance ratio is 0.25 or more and 2.30 or less, said Au abundance ratio being an area ratio of a portion covered with Au to a portion at which Pt is exposed in a surface of noble metal particles included in said outer pump electrode.

3. The gas sensor according to claim 1, wherein
said at least one internal space comprises a first internal space and a second internal space,
said NOx measurement electrode is located inside said second internal space, and has NOx reducing ability,
said sensor element further includes:
a gas inlet through which said measurement gas is introduced from said external space into said sensor element;
an inner pump electrode formed to face said first internal space; and
an auxiliary pump electrode formed to face said second internal space,
said gas inlet and said first internal space, and said first internal space and said second internal space each communicate with each other via a diffusion control part providing a predetermined diffusion resistance to said measurement gas,
said inner pump electrode, said outer pump electrode, and a solid electrolyte between said inner pump electrode and said outer pump electrode constitute a main pump cell pumping in or pumping out oxygen between said first internal space and said external space,
said auxiliary pump electrode, said outer pump electrode, and a solid electrolyte between said auxiliary pump electrode and said outer pump electrode constitute an auxiliary pump cell that is an electrochemical pump cell pumping out oxygen from said second internal space to said external space, and
said measurement pump cell pumps out oxygen generated by reducing, with said NOx measurement electrode, NOx in said measurement gas having oxygen partial pressure controlled by said main pump cell and said auxiliary pump cell, thereby allowing said pump current to flow between said NOx measurement electrode and said outer pump electrode.

4. A catalyst diagnosis system for diagnosing a state of a catalyst that is located on an exhaust path of an internal combustion engine, and oxidizes or adsorbs a target gas containing at least one of a hydrocarbon gas and a carbon monoxide gas included in an exhaust gas from said internal combustion engine, said catalyst diagnosis system comprising:
a gas sensor detecting a predetermined gas component in a measurement gas;
a temperature sensor outputting temperature of said catalyst; and
a controller controlling said catalyst diagnosis system, wherein
said gas sensor is located downstream from said catalyst on said exhaust path, and includes:
a sensor element including a lamination of a plurality of oxygen-ion conductive solid electrolyte layers; and
a heater located inside said sensor element to heat said sensor element,
said sensor element includes:
a NOx sensor part; and
a HC sensor part,
said NOx sensor part includes:
at least one internal space into which said measurement gas is introduced from an external space;
a NOx measurement electrode formed to face said at least one internal space;
an outer pump electrode formed on a surface of said sensor element; and
a reference electrode located between two of said plurality of oxygen-ion conductive solid electrolyte layers to be in contact with a reference gas, and
said NOx sensor part has a measurement pump cell that is an electrochemical pump cell constituted by said NOx measurement electrode, said outer pump electrode, and a solid electrolyte between said NOx measurement electrode and said outer pump electrode,
said HC sensor part has a mixed potential cell constituted by said outer pump electrode, said reference electrode, and a solid electrolyte between said outer pump electrode and said reference electrode, said outer pump electrode having catalytic activity inactivated for said hydrocarbon gas and carbon monoxide,
said gas sensor is configured to be capable of selectively performing a HC mode for determining a HC concentration in said measurement gas and a NOx mode for determining a NOx concentration is said measurement gas in accordance with temperature of said sensor element,
in said HC mode, said heater heats at least said HC sensor part of said sensor element to a first temperature which is 400° C. or higher and 650° C. or lower, and said gas sensor determines said HC concentration based on a potential difference occurring between said outer pump electrode and said reference electrode in said mixed potential cell,
in said NOx mode, said heater heats at least said NOx sensor part of said sensor element to a second temperature which is 600° C. or higher and 900° C. or lower, and is higher than said first temperature, and said gas sensor determines said NOx concentration based on a pump current flowing between said NOx measurement electrode and said outer pump electrode in a state of controlling a voltage applied between said NOx measurement electrode and said outer pump electrode to maintain a potential difference between said NOx measurement electrode and said reference electrode constant, and
in said catalyst diagnosis system,
threshold data set in advance is held in a predetermined storage, said threshold data describing a threshold condition for use in diagnosis of degradation of said catalyst, and
said controller is configured to:
cause said heater to heat said sensor element so that at least said HC sensor part is heated to said first temperature from starting of said internal combustion engine;
obtain, over time, said potential difference occurring between said outer pump electrode and said reference electrode in said mixed potential cell while maintaining said HC sensor part at said first temperature;
identify said temperature of said catalyst output from said temperature sensor when said potential difference decreases to meet said threshold condition as a light-off temperature of said catalyst; and
diagnose a degree of degradation of said catalyst based on said light-off temperature.

5. The catalyst diagnosis system according to claim 4, wherein
said controller is configured to:
cause said heater to heat said sensor element so that at least said NOx sensor part is heated to said second temperature after identification of said light-off temperature; and
be capable of monitoring said NOx concentration at a location downstream from said catalyst during steady-state operation of said internal combustion engine based on said pump current flowing between said NOx measurement electrode and said outer pump electrode when said NOx sensor part is at said second temperature.

6. A method of diagnosing a state of a catalyst that is located on an exhaust path of an internal combustion engine and oxidizes or adsorbs a target gas containing at least one of a hydrocarbon gas and a carbon monoxide gas included in an exhaust gas from said internal combustion engine, said method comprising
a) locating a gas sensor downstream from said catalyst on said exhaust path, said gas sensor detecting a predetermined gas component in a measurement gas, wherein
said gas sensor is located downstream from said catalyst on said exhaust path, and includes:
a sensor element including a lamination of a plurality of oxygen-ion conductive solid electrolyte layers; and
a heater located inside said sensor element to heat said sensor element,
said sensor element includes:
a NOx sensor part; and
a HC sensor part,
said NOx sensor part includes:
at least one internal space into which said measurement gas is introduced from an external space;
a NOx measurement electrode formed to face said at least one internal space;
an outer pump electrode formed on a surface of said sensor element; and
a reference electrode located between two of said plurality of oxygen-ion conductive solid electrolyte layers to be in contact with a reference gas, and
said NOx sensor part has a measurement pump cell that is an electrochemical pump cell constituted by said NOx measurement electrode, said outer pump electrode, and a solid electrolyte between said NOx measurement electrode and said outer pump electrode,
said HC sensor part has a mixed potential cell constituted by said outer pump electrode, said reference electrode, and a solid electrolyte between said outer pump electrode and said reference electrode, said outer pump electrode having catalytic activity inactivated for said hydrocarbon gas and carbon monoxide,
said gas sensor is configured to be capable of selectively performing a HC mode for determining a HC concentration in said measurement gas and a NOx mode for determining a NOx concentration is said measurement gas in accordance with temperature of said sensor element,
in said HC mode, said heater heats at least said HC sensor part of said sensor element to a first temperature which is 400° C. or higher and 650° C. or lower, and said gas sensor determines said HC concentration based on a potential difference occurring between said outer pump electrode and said reference electrode in said mixed potential cell,
in said NOx mode, said heater heats at least said NOx sensor part of said sensor element to a second temperature which is 600° C. or higher and 900° C. or lower, and is higher than said first temperature, and said gas sensor determines said NOx concentration based on a pump current flowing between said NOx measurement electrode and said outer pump electrode in a state of controlling a voltage applied between said NOx measurement electrode and said outer pump electrode to maintain a potential difference between said NOx measurement electrode and said reference electrode constant, and
said method comprises:
b) causing said heater to heat said sensor element so that at least said HC sensor part is heated to said first temperature from starting of said internal combustion engine;
c) measuring, over time, said potential difference occurring between said outer pump electrode and said reference electrode in said mixed potential cell while maintaining said HC sensor part at said first temperature;
d) identifying said temperature of said catalyst when said potential difference decreases to meet a threshold condition set in advance as a light-off temperature of said catalyst; and
e) diagnosing a degree of degradation of said catalyst based on said light-off temperature.

7. The gas sensor according to claim 2, wherein
said at least one internal space comprises a first internal space and a second internal space,
said NOx measurement electrode is located inside said second internal space, and has NOx reducing ability,
said sensor element further includes:
a gas inlet through which said measurement gas is introduced from said external space into said sensor element;
an inner pump electrode formed to face said first internal space; and
an auxiliary pump electrode formed to face said second internal space,
said gas inlet and said first internal space, and said first internal space and said second internal space each communicate with each other via a diffusion control part providing a predetermined diffusion resistance to said measurement gas,
said inner pump electrode, said outer pump electrode, and a solid electrolyte between said inner pump electrode and said outer pump electrode constitute a main pump cell pumping in or pumping out oxygen between said first internal space and said external space,
said auxiliary pump electrode, said outer pump electrode, and a solid electrolyte between said auxiliary pump electrode and said outer pump electrode constitute an auxiliary pump cell that is an electrochemical pump cell pumping out oxygen from said second internal space to said external space, and
said measurement pump cell pumps out oxygen generated by reducing, with said NOx measurement electrode, NOx in said measurement gas having oxygen partial pressure controlled by said main pump cell and said auxiliary pump cell, thereby allowing said pump current to flow between said NOx measurement electrode and said outer pump electrode.
